(19) United States
(12) Patent Application Publication
(10) Pub. No.: US 2008/0011797 A1
(43) Pub. Date: Jan. 17, 2008

(54) HITCH MOUNTED TIRE CARRIER SUPPORT STRUCTURE

(76) Inventor: Anthony J. Newbill, Wickenburg, AZ (US)

Correspondence Address: SCHMEISER OLSEN & WATTS, 18 E UNIVERSITY DRIVE, SUITE # 101, MESA, AZ, 85201, US

(21) Appl. No.: 11/863,180

(22) Filed: Sep. 27, 2007

Related U.S. Application Data
(63) Continuation-in-part of application No. 11/688,781, filed on Mar. 20, 2007.
(63) Continuation-in-part of application No. 10/784,654, filed on Feb. 23, 2004, now abandoned.

(51) Int. Cl. B60R 11/06

(52) U.S. Cl. 224/502; 29/592

(57) ABSTRACT

A vehicle includes a vehicle frame which carries a trailer hitch mount. A tire carrier support structure is slidingly engaged with the trailer hitch mount. A mounting post and closure fastener are carried by the tire carrier support structure and a tire carrier assembly is rotatably mounted to the mounting post.

### CROSS-REFERENCE TO RELATED APPLICATIONS

This application is a continuation-in-part of U.S. patent application Ser. Nos. 10/784,654 and 11/688,781 filed on Feb. 23, 2004 and Mar. 20, 2007, respectively, the contents of both of which are incorporated herein by reference.

### BACKGROUND OF THE INVENTION

1. Field of the Invention

This invention relates generally to vehicles which carry a spare tire.

2. Description of the Related Art

Most vehicles have a spare tire, which can be carried by it at many different locations. For example, some spare tires are carried on the undercarriage of the vehicle, but most of them are carried in a vehicle trunk. Sport utility vehicles, however, typically do not have a vehicle trunk so the spare tire must be carried elsewhere. Further, tires for sport utility vehicles are generally large in size and weight, which makes it inconvenient to position them on and remove them from the undercarriage and the vehicle's interior.

Hence, sport utility vehicles often include an external tire carrier assembly for carrying the spare tire. Examples of these tire carrier assemblies can be found in U.S. Pat. Nos. 5,333,766, 5,186,371 and 5,104,015. The tire carrier assembly is often positioned at the rearward end of the vehicle. However, there are a limited number of options available for coupling the tire carrier assembly to the rearward end of the vehicle.

### BRIEF SUMMARY OF THE INVENTION

The present invention employs a hitch mounted tire carrier support structure which carries a tire carrier assembly at the rearward end of a vehicle. The tire carrier support structure is carried by a trailer hitch mount included with the vehicle so that it is positioned proximate to its bumper. In one embodiment, the tire carrier support structure is slidingly engaged with the trailer hitch mount.

The tire carrier support structure is stronger and more rugged than the vehicle bumper, so it is capable of carrying more weight. Hence, the tire carrier assembly is positioned so that most of its weight is applied to the tire carrier support structure instead of the vehicle bumper.

The tire carrier assembly is rotatably mounted to the tire carrier support structure so that it is repeatably moveable between stowed and deployed positions. In some embodiments, the tire carrier assembly is repeatably moveable between raised and lowered positions. Further, in some embodiments, the tire carrier assembly is repeatably moveable between extended and retracted positions.

These and other features, aspects, and advantages of the present invention will become better understood with reference to the following drawings and description.

### BRIEF DESCRIPTION OF THE DRAWINGS

FIG. 1 is a rear perspective view of a vehicle which includes a tire carrier support structure, in accordance with the invention.

FIGS. 2a and 2b are perspective and side views, respectively, of the tire carrier support structure of FIG. 1.

FIG. 2c is a close-up perspective view of the tire carrier support structure being mounted to a trailer hitch mount of FIG. 1, in accordance with the invention.

FIG. 3 is a side view of another embodiment of a tire carrier support structure, in accordance with the invention.

FIGS. 4a and 4b are perspective and side views, respectively, of an embodiment of a tire carrier support structure, in accordance with the invention, which carries a trailer hitch.

FIGS. 5a, 5b and 5c are perspective views of a rotary latch, pin latch and ball hitch latch, respectively.

FIGS. 6a and 6b are side views of a tire carrier assembly carried by the tire carrier support structure of FIG. 1, in accordance with the invention, wherein the tire carrier assembly is moveable between stowed and deployed positions.

FIGS. 7a, 7b and 7c are side views of a tire carrier assembly carried by the tire carrier support structure of FIG. 1, in accordance with the invention, wherein the tire carrier assembly is moveable between stowed and deployed positions and raised and lowered positions.

FIGS. 8a, 8b, 8c, 8d and 8e are side views of a tire carrier assembly carried by the tire carrier support structure of FIG. 1, in accordance with the invention, wherein the tire carrier assembly is moveable between stowed and deployed positions, raised and lowered positions and extended and retracted positions.

FIGS. 9a, 9b and 9c are front, back and side views, respectively, of the tire carrier assembly of FIG. 8a carrying a vehicle accessory, in accordance with the invention.

FIG. 9d is an exploded perspective view of a hub unit included with the tire carrier assembly of FIG. 8a, and a spare tire and a spare tire cover, in accordance with the invention.

FIG. 10a is a flow diagram of a method, in accordance with the invention, of mounting a tire carrier support structure to a vehicle.

FIG. 10b is a flow diagram of a method, in accordance with the invention, of mounting a tire carrier assembly to a vehicle.

FIG. 10c is a flow diagram of a method, in accordance with the invention, of mounting a tire carrier support structure to a vehicle.

FIG. 10d is a flow diagram of a method, in accordance with the invention, of manufacturing a tire carrier support structure.

### DETAILED DESCRIPTION OF THE INVENTION

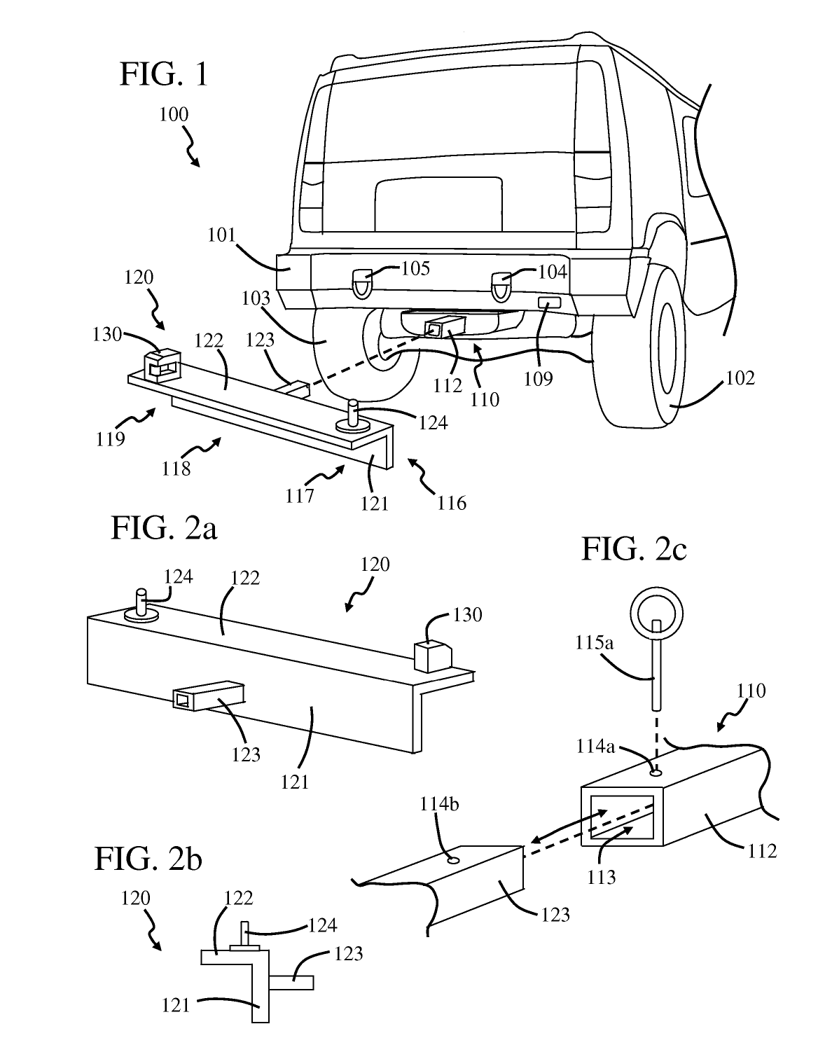

FIG. 1 is a rear perspective view of a vehicle 100, in accordance with the invention. In this embodiment, vehicle 100 includes a vehicle frame (not shown) which carries a trailer hitch mount 110 proximate to its rearward end. The rearward end of vehicle 100 is near rear wheels 102 and 103. Trailer hitch mount 110 is generally used so that a trailer can be towed by vehicle 100. Vehicle 100 can be of many different types, but here it is embodied as a Hummer, which is the civilian version of the military Hum Vee vehicle. Vehicle 100 also includes a vehicle bumper 101 and D-ring assemblies 104 and 105 which are carried by the vehicle frame, wherein D-ring assemblies 104 and 105 are positioned away from trailer hitch mount 110. It should be noted that the vehicle frame provides support for the components included with vehicle 100, such as its engine, front and rear wheels, suspension and body. However, some of these components are not shown for simplicity.

In accordance with the invention, vehicle 100 includes a tire carrier support structure 120 carried by trailer hitch mount 110 so it is proximate to vehicle bumper 101. Tire carrier support structure 120 can be carried by trailer hitch mount 110 in many different ways, one of which will be discussed in more detail with FIG. 2c. It should be noted that tire carrier support structure 120 is stronger and more rugged than vehicle bumper 101, so support structure 120 is capable of carrying more weight.

In accordance with the invention, tire carrier support structure 120 includes a mounting post 124 and a closure fastener, which is embodied as a rotary latch 130. More information regarding rotary latch 130 is provided with FIG. 4a. Mounting post 124 and rotary latch 130 can be positioned at many different locations, but here they are positioned proximate to end regions 117 and 119, respectively, of support structure 120. End regions 117 and 119 are near rear wheels 102 and 103, respectively, when tire carrier support structure 120 is carried by trailer hitch mount 110. It should be noted, however, that rotary latch 130 and/or mounting post 124 can be positioned at many other locations, such as in an intermediate region 118 of support structure 120, wherein intermediate region 118 is between end regions 117 and 119. Tire carrier support structure 120 can be of many different types, one of which will be discussed in more detail presently.

FIGS. 2a and 2b are perspective and side views, respectively, of tire carrier support structure 120. It should be noted that the side view of FIG. 2b is as seen in a direction 116 of FIG. 1. In this embodiment, tire carrier support structure 120 includes a base member 122 and a sidewall member 121 extending downwardly therefrom. Mounting post 124 and rotary latch 130 are carried by base member 122. Mounting post 124 and rotary latch 130 can be carried by base member 122 in many different ways, such as by coupling them together by welding. In other embodiments, mounting post 124 and base member 122 are a single integral piece. It should be noted that sidewall member 121 and base member 122 can be separate pieces coupled together, such as by welding, or they can be a single integral piece. It should also be noted that in other embodiments, tire carrier support structure can include sidewall member 121 or base member 122. Support structure 120 includes sidewall member 121 and base member 122 in this embodiment for illustrative purposes. Further, sidewall member 121 and base member 122 can have many different shapes and these shapes can be curved or flat.

In accordance with the invention, tire carrier support structure 120 includes a tire carrier mounting bar 123 for engaging trailer hitch mount 110. In this way, tire carrier support structure 120 is carried by trailer hitch mount 110 proximate to vehicle bumper 101. In this embodiment, tire carrier mounting bar 123 is carried by sidewall member 121 and extends outwardly therefrom. Tire carrier mounting bar 123 has a length chosen so that base member 122 and sidewall member 121 are spaced a desired distance from vehicle bumper 101. In this way, tire carrier support structure 120 is provided with a desired amount of clearance from vehicle bumper 101. Sidewall member 121 is positioned further away from vehicle bumper 101 as the length of tire carrier mounting bar 123 increases. Further, sidewall member 121 is positioned closer to vehicle bumper 101 as the length of tire carrier mounting bar 123 decreases.

In this embodiment, tire carrier mounting bar 123 and sidewall member 121 are on the same side of base member 122, and extend perpendicular to each other. However, mounting bar 123 and sidewall member 121 can extend from each other at non-perpendicular angles. Base member 122, sidewall member 121 and tire carrier mounting bar 123 are coupled together, which can be done in many different ways. For example, they can be coupled together because they are made from the same piece or they can be separate pieces coupled together, such as by welding.

In this embodiment, base member 122 and sidewall member 121 are elongate so they extend along the length of vehicle bumper 101 when carried by trailer hitch mount 110. In accordance with the invention, tire carrier support structure 120 does not extend along the entire length of vehicle bumper 101. Instead, opposed ends 117 and 119 of support structure 120 terminate between corresponding opposed ends of vehicle bumper 101. This is useful for many different reasons, such as the bumper standards set forth in the United States by the National Highway Safety Standards Commission and the National Transportation Safety Board. The bumper standards state that a vehicle bumper should be collapsible in response to a large enough force being applied to it, such as the force of a collision.

To allow vehicle bumper 101 to be collapsible, tire carrier support structure 120 does not extend all the way to opposed ends of vehicle bumper 101. If tire carrier support structure 120 did extend all the way to opposed ends of vehicle bumper 101, it could interfere with the ability of vehicle bumper 101 to collapse in response to the force of a collision. This is because, as mentioned above, tire carrier support structure 120 is made of a stronger and more rugged material than vehicle bumper 101. Hence, vehicle bumper 101 is collapsible in response to the force of a collision, without interference from support structure 120.

FIG. 2c is a close-up perspective view of tire carrier mounting bar 123 and trailer hitch mount 110. In this embodiment, trailer hitch mount 110 includes a trailer hitch bar 112 which has an opening 113 sized and shaped to slidingly receive tire carrier mounting bar 123. Hence, tire carrier support structure 120 is slidingly engaged with trailer hitch mount 110.

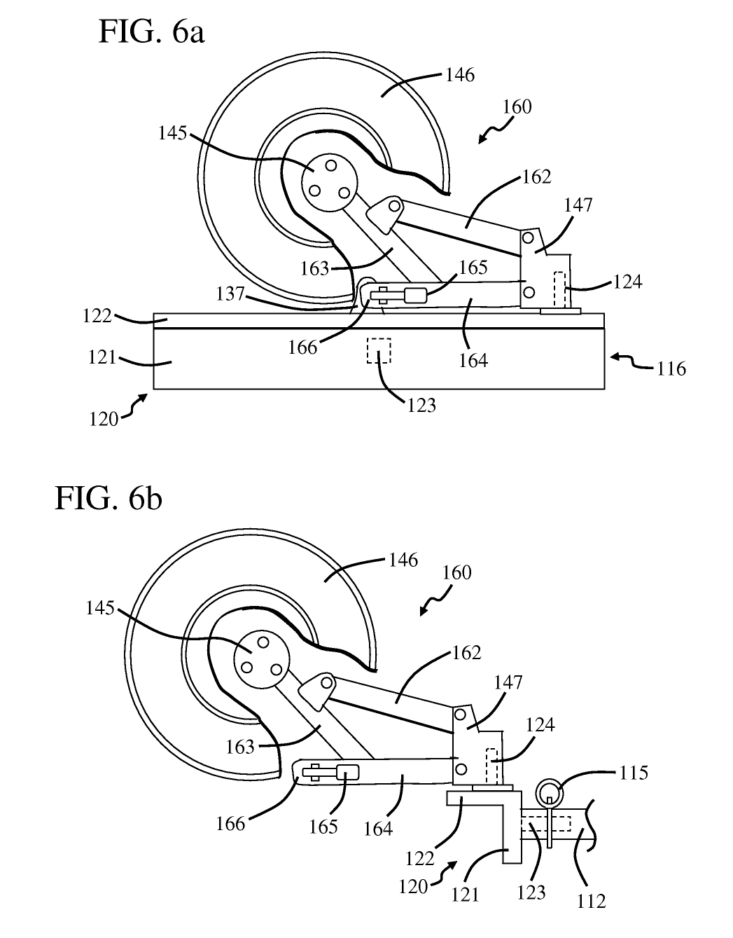

In this embodiment, trailer hitch bar 112 and tire carrier mounting bar 123 include openings 114a and 114b, respectively, which can be aligned when tire carrier mounting bar 123 is slidingly engaged with trailer hitch bar 112. A pin 115a can extend through openings 114a and 114b, as shown in FIGS. 2c and 6b, when they are aligned. Trailer hitch bar 112 and tire carrier mounting bar 123 are locked together when their movement relative to each other is restricted by pin 115a. Further, trailer hitch bar 112 and tire carrier mounting bar 123 are unlocked when their movement relative to each other is not restricted by pin 115a. In this way, tire carrier support structure 120 is moveable between locked and unlocked conditions with trailer hitch mount 110.

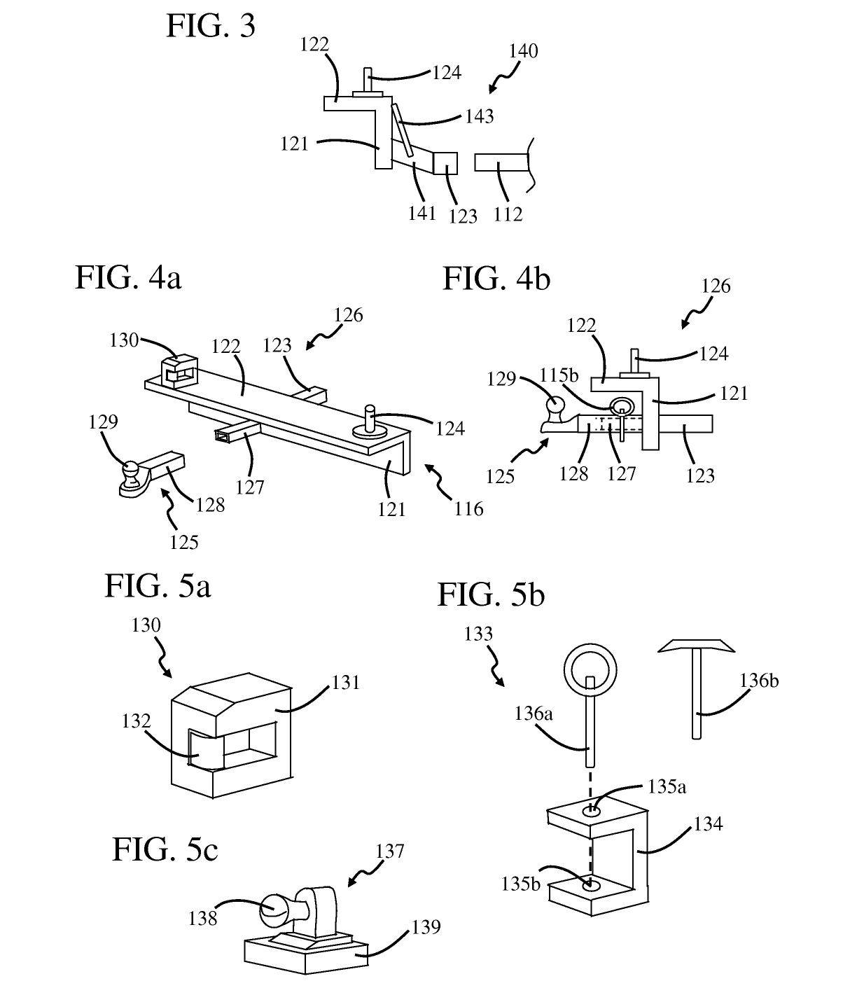

FIG. 3 is a side view of a tire carrier support structure 140, in accordance with the invention, wherein tire carrier support structure 140 can replace tire carrier support structure 120. In this embodiment, tire carrier support structure 140 includes sidewall member 121 extending downwardly from base member 122, as described above. Further, mounting post 124 is carried by base member 122 and extends upwardly therefrom. It should be noted that tire carrier support structure 140 can also carry rotary latch 130, but this is not shown here for simplicity.

In accordance with the invention, tire carrier support structure 140 includes an extension bar 141 coupled to sidewall member 121. Extension bar 141 extends at a downward angle away from sidewall member 121. Tire carrier support structure 140 includes a support arm 143 which extends between sidewall member 121 and extension bar 141, wherein support arm 143 provides support to extension bar 141. It should be noted that tire carrier support structure 140 typically includes two support arms that support extension bar 141, but only one is shown here for simplicity.

In accordance with the invention, tire carrier support structure 140 includes hitch mounting bar 123 carried by extension bar 141. As discussed above, hitch mounting bar 123 is sized and shaped to be received by opening 113 (FIG. 2c) of trailer hitch bar 112 so they are slidingly engaged together. In this way, tire carrier support structure 140 is carried by trailer hitch mount 110. It should be noted that extension bar 141 and tire hitch mounting bar 123 can be separate pieces coupled together, such as by welding, or a single integral piece.

In accordance with the invention, the lengths of tire carrier mounting bar 123 and extension bar 141 are chosen so that base member 122 and sidewall member 121 are spaced a desired distance from vehicle bumper 101. In this way, tire carrier support structure 140 is provided with a desired amount of clearance from vehicle bumper 101. Further, the angle of extension bar 141 with sidewall member 121 is chosen to provide the desired amount of clearance. Sidewall member 121 is moved away from vehicle bumper 101 as the length of tire carrier mounting bar 123 increases. Further, sidewall member 121 is moved towards vehicle bumper 101 as the length of tire carrier mounting bar 123 decreases. Base member 122 is moved upwardly as the length of extension bar 141 increases. Further, base member 122 is moved downwardly as the length of extension bar 141 decreases. Base member 122 is moved away from vehicle bumper 101 as the angle between extension bar 141 and sidewall member 121 increases. Further, base member 122 is moved towards vehicle bumper 101 as the angle between extension bar 141 and sidewall member 121 decreases.

FIGS. 4a and 4b are perspective and side views, respectively, of an embodiment of a tire carrier support structure 126, in accordance with the invention, which carries a trailer hitch 125. In this embodiment, trailer hitch 125 includes a ball hitch 129 carried by a trailer hitch bar 128. It should be noted that trailer hitch bar 128 can be engaged with trailer hitch bar 112 when tire carrier support structure 120 is not. Trailer hitch 125 can be carried by tire carrier support structure 120 in many different ways, one of which will be discussed in more detail presently.

In accordance with the invention, tire carrier support structure 120 includes a trailer hitch mounting bar 127 for engaging trailer hitch bar 128. Trailer hitch mounting bar 127 can engage trailer hitch bar 128 in many different ways, but here they are slidingly engaged with each other. Trailer hitch mounting bar 127 and trailer hitch bar 128 can be locked together so that their movement relative to each other is restricted. Trailer hitch mounting bar 127 and trailer hitch bar 128 can be locked together in many different ways, such as with a locking pin 115b (FIG. 4b) which extends through them. Trailer hitch mounting bar 127 can be positioned at many different locations, but, in this embodiment, it is coupled to sidewall member 121 at a location opposed to tire carrier mounting bar 123. In this way, trailer hitch 125 is carried by tire carrier support structure 126.

It should be noted that, in some embodiments, tire carrier mounting bar 123 and trailer hitch bar 127 are a single integral piece which extend through sidewall member 121. However, in this embodiment, tire carrier mounting bar 123 and trailer hitch bar 127 are separate members coupled to sidewall member 121. Tire carrier mounting bar 123 and trailer hitch bar 127 can be coupled to sidewall member 121 in many different ways, such as by welding. In still other embodiments, tire carrier mounting bar 123, trailer hitch bar 127 and sidewall member 121 can be a single integral piece.

FIG. 5a is a perspective view of rotary latch 130. There are many different types of rotary latches that can be used as rotary latch 130, with one example being disclosed in U.S. Pat. No. 6,419,286. These types of rotary latches generally provide closure, as will be discussed in more detail below. In this embodiment, rotary latch 130 includes a latch body 131 with a latch plate 132. Latch plate 132 is spring loaded so it is repeatably moveable between positions towards and away from latch body 131. It should be noted that rotary latch 130 can be replaced with many other different types of latches, several of which will be discussed in more detail presently.

FIG. 5b is a perspective view of a pin latch 133 which can be carried by tire carrier support structure 120. In this embodiment, pin latch 133 includes a latch body 134 with opposed openings 135a and 135b spaced apart from each other. Openings 135a and 135b are sized and shaped to receive a pin 136a or a t-pin 136b.

FIG. 5c is a perspective view of a ball hitch latch 137, which can be carried by tire carrier support structure 120. In this embodiment, ball hitch latch 137 includes a latch body 139 which carries a ball hitch 138. More information regarding a ball hitch latch can be found in U.S. Patent Application No. 20050184111.

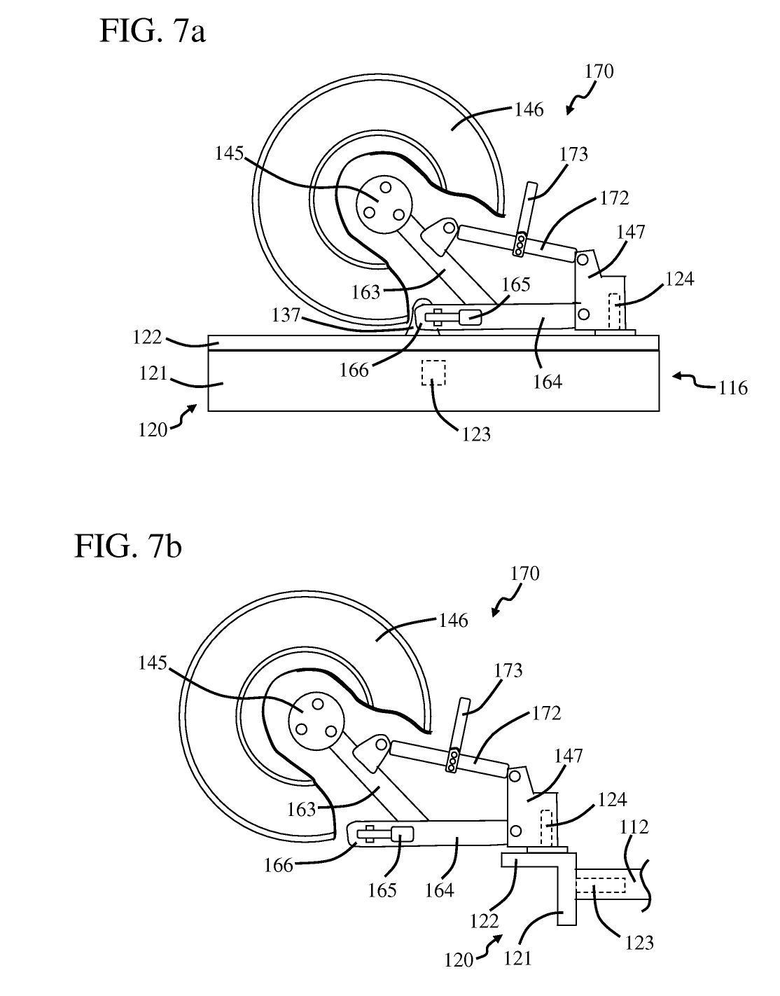

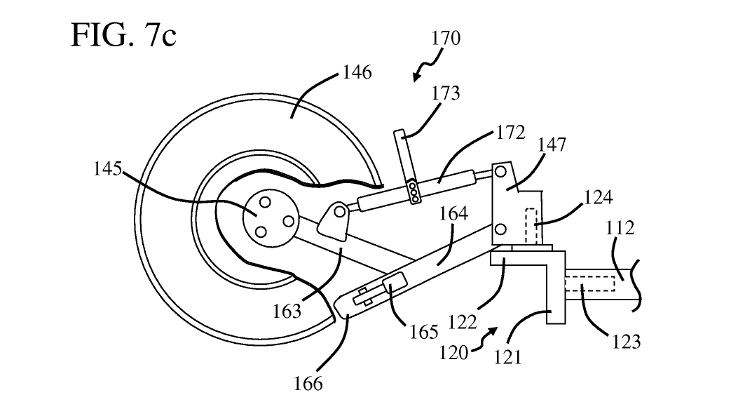

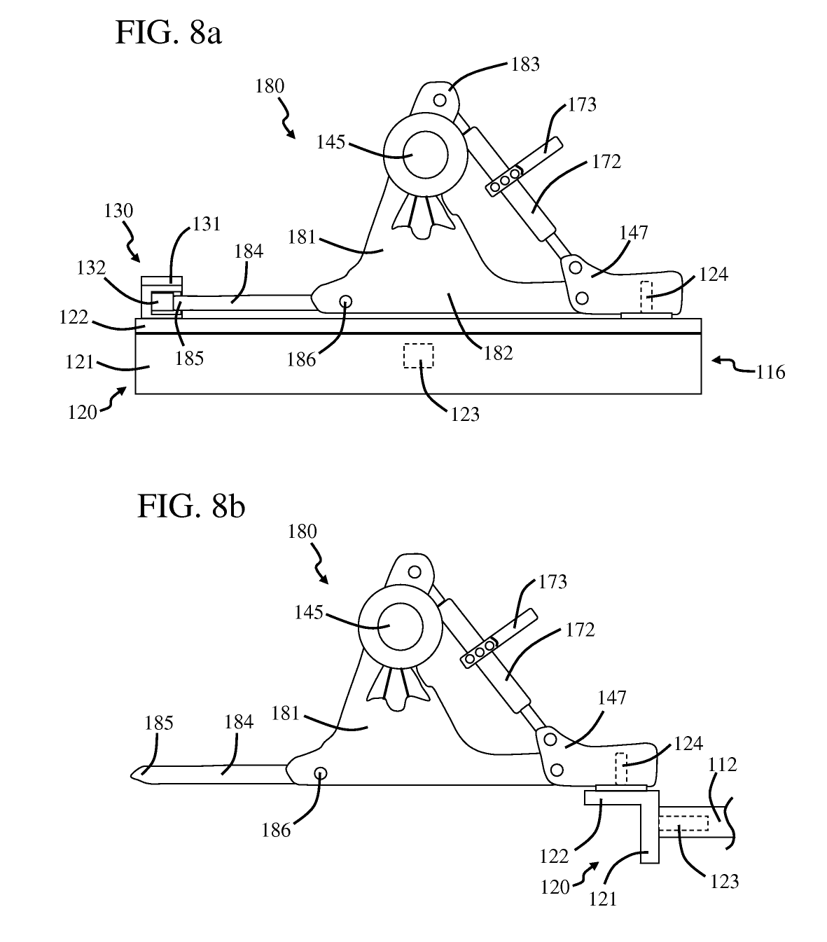

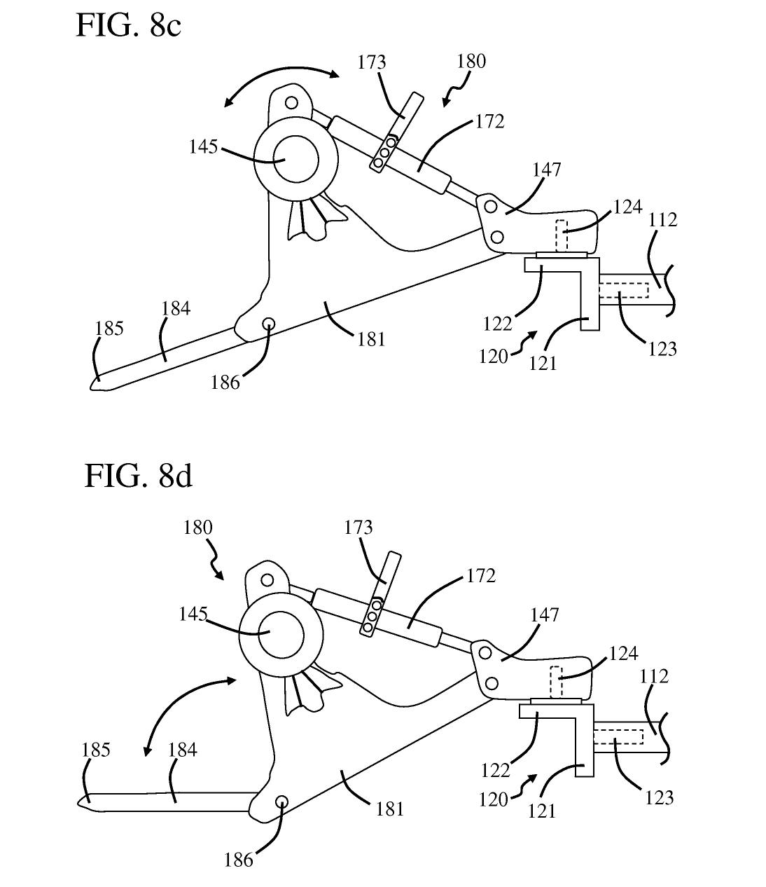

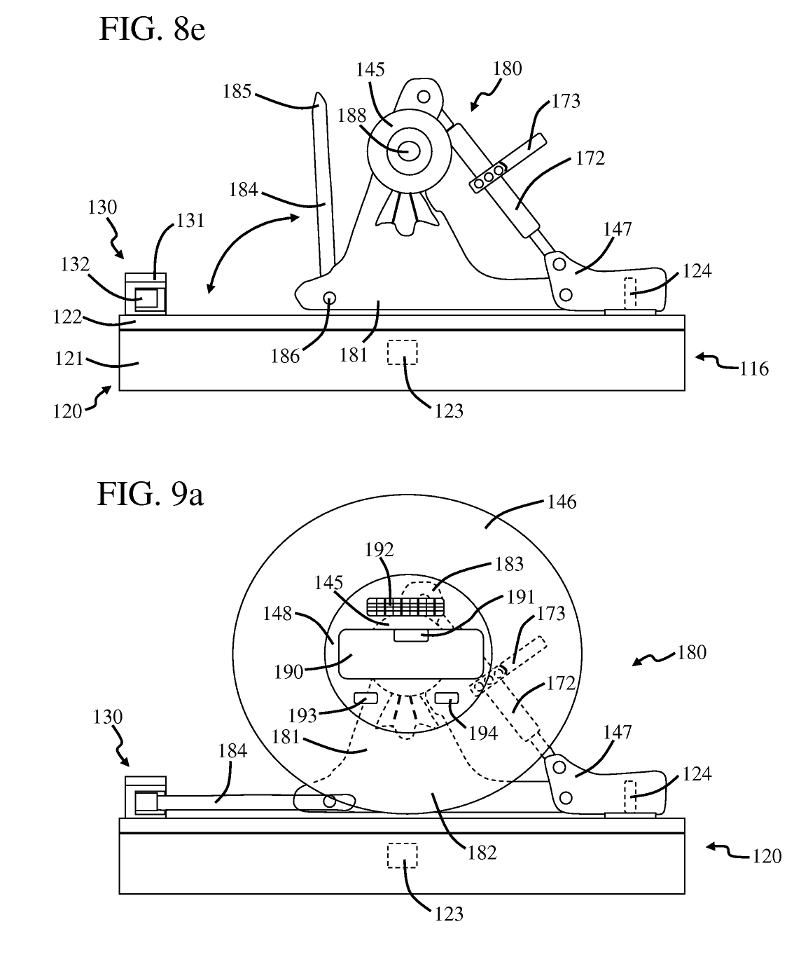

It should be noted that rotary latch 130, pin latch 133 and ball hitch latch 137 can be positioned at many different locations with tire carrier support structure 120. For example, rotary latch 130, pin latch 133 and ball hitch latch 137 can be carried by base member 122 and positioned proximate to end region 119 or intermediate region 118. In FIGS. 6a and 6b and FIGS. 7a, 7b and 7c, ball hitch latch 137 is positioned proximate to intermediate region 118. Further, in FIGS. 8a, 8b, 8c and 8d, rotary latch 130 is positioned proximate to end region 119.

FIGS. 6a and 6b are side views of a tire carrier assembly 160 carried by tire carrier support structure 120, in accordance with the invention. It should be noted that the side view of FIG. 6b is as seen in direction 116 of FIG. 6a. Tire carrier assembly 160 is carried by tire carrier support structure 120 because support structure 120 is capable of carrying more weight than vehicle bumper 101. In this way, tire carrier assembly 160 is positioned so that most of its weight is applied to tire carrier support structure 120 and trailer hitch mount 110 instead of vehicle bumper 101. This is useful because tire carrier support structure 120 is stronger and more rugged than vehicle bumper 101, so it is less likely to fail in response to the weight of spare tire carrier assembly 160. Hence, spare tire carrier assembly 160 can include more and heavier components, several of which are discussed in more detail below. Tire carrier mounting bar 123 is slidingly engaged with trailer hitch mounting bar 112, as shown in FIG. 6b. Further, pin 115a extends through openings 114a and 114b (FIG. 2c) so that mounting bar 123 and trailer hitch mounting bar 112 are restricted from moving relative to each other. In this way, tire carrier support structure 120 and trailer hitch mount 110 are locked together.

Tire carrier assembly 160 can be carried by tire carrier support structure 120 in many different ways. In this embodiment, tire carrier support structure 120 includes mounting post 124 carried by tire carrier support structure 120, wherein mounting post 124 is attached to base member 122 and extends upwardly therefrom. Further, tire carrier assembly 160 includes a bracket 147 which has an opening (not shown) sized and shaped to receive mounting post 124. Bracket 147 can rotate relative to mounting post 124 when the opening in bracket 147 receives mounting post 124. In this way, tire carrier assembly 160 is rotatably mounted to tire carrier support structure 120.

Tire carrier assembly 160 is rotatably mounted so it is repeatably moveable between stowed and deployed conditions, as shown in FIGS. 6a and 6b, respectively. When tire carrier assembly 160 is in its stowed position, it extends along tire carrier support structure 120. Further, when tire carrier assembly 160 is in its deployed position, tire carrier arm assembly 160 extends at a non-zero angle relative to tire carrier support structure 120. It should be noted that bracket 147 rotates relative to mounting post 124 when tire carrier assembly 160 moves between the stowed and deployed positions.

In this embodiment, tire carrier assembly 160 includes a latching arm 164 connected to a lower connection point of bracket 147. Further, tire carrier assembly 160 includes a tire carrier arm 163 extending upwardly from latching arm 164. A hub unit 145 is carried by tire carrier arm 163 and a spare tire 146 is engaged with hub unit 145. In this way, tire carrier assembly 160 carries a spare tire. Tire carrier assembly 160 also includes a support arm 162 connected between tire carrier arm 163, proximate to hub unit 145, and an upper connection point of bracket 147. Support arm 162 provides support to tire carrier arm 163 and latching arm 164. It should be noted that latching arm 164 carries a ball latch 165 for latching tire carrier assembly 160 in the stowed position, as will be discussed in more detail presently.

In this embodiment, tire carrier support structure 120 includes ball hitch latch 137 (FIG. 5c) positioned in intermediate region 118 (FIG. 1). Further, latch arm 164 includes a ball hitch receiver 166 positioned at its distal end. More information regarding ball hitch latch 137 and ball hitch receiver 166 can be found in U.S. Patent Application No. 20050184111. Ball hitch receiver 166 is sized and shaped to receive ball hitch 138. Further, ball latch 165 holds ball hitch receiver 166 and ball hitch 138 together so that tire carrier assembly 160 is held in the stowed position. However, ball latch 165 can be activated so that ball hitch 138 is released from ball hitch receiver 166 and tire carrier assembly 160 can be moved to the deployed condition. In this way, tire carrier assembly 160 is repeatably moveable between latched and unlatched positions relative to ball hitch latch 137. It should be noted that ball hitch latch 137 can be replaced with another latch, such as rotary latch 130 or pin latch 133.

FIGS. 7a, 7b and 7c are side views of a tire carrier assembly 170 carried by tire carrier support structure 120, in accordance with the invention. In this embodiment, tire carrier assembly 170 is repeatably moveable between stowed and deployed positions, as discussed with FIGS. 6a and 6b. Further, in accordance with the invention, tire carrier assembly 170 is repeatably moveable between raised and lowered positions, as will be discussed in more detail presently. FIG. 7a shows tire carrier assembly 170 in the raised and stowed position, FIG. 7b shows tire carrier assembly 170 in the raised and deployed position and FIG. 7c shows tire carrier assembly 170 in the lowered and deployed position.

Tire carrier assembly 170 includes tire carrier assembly 160 as described with FIGS. 6a and 6b. However, in this embodiment, support arm 162 is replaced with an actuator 172 operatively coupled with an actuator handle 173. Actuator 172 allows tire carrier arm assembly 170 to be repeatably moveable between raised and lowered positions, as shown in FIGS. 7b and 7c. Actuator 172 can be of many different types, such as a linear actuator. Examples of linear actuators include hydraulic and pneumatic cylinder actuators. One particular type of linear actuator is manufactured by Thompson Saginaw and is known as Model No. PPA23. More information about linear actuators can be found in U.S. Pat. No. 6,659,318, which is incorporated herein by reference.

In another embodiment, actuator 172 includes a threaded sleeve and a threaded shaft operatively coupled together. The threaded shaft and threaded sleeve are operatively coupled together so they can be moved relative to each other in response to moving a hand grip. More information about actuators that include a threaded shaft and sleeve can be found in U.S. Pat. No. 6,659,318.

FIGS. 8a, 8b, 8c, 8d and 8e are side views of a tire carrier assembly 180 carried by tire carrier support structure 120, in accordance with the invention. In this embodiment, tire carrier assembly 180 is repeatably moveable between stowed and deployed positions, as discussed with FIGS. 6a and 6b and FIGS. 7a, 7b and 7c. Tire carrier assembly 180 is shown in stowed and deployed positions in FIGS. 8a and 8b, respectively. Further, in accordance with the invention, tire carrier assembly 180 is repeatably moveable between raised and lowered positions, as discussed with FIGS. 7a, 7b and 7c. Tire carrier assembly 180 is shown in raised and lowered positions in FIGS. 8b and 8c, respectively. Also, in accordance with the invention, tire carrier assembly 180 is repeatably moveable between extended and retracted positions, as will be discussed in more detail presently. Tire carrier assembly 180 is shown in extended positions in FIGS. 8a, 8b and 8c and in retracted positions in FIGS. 8d and 8e.

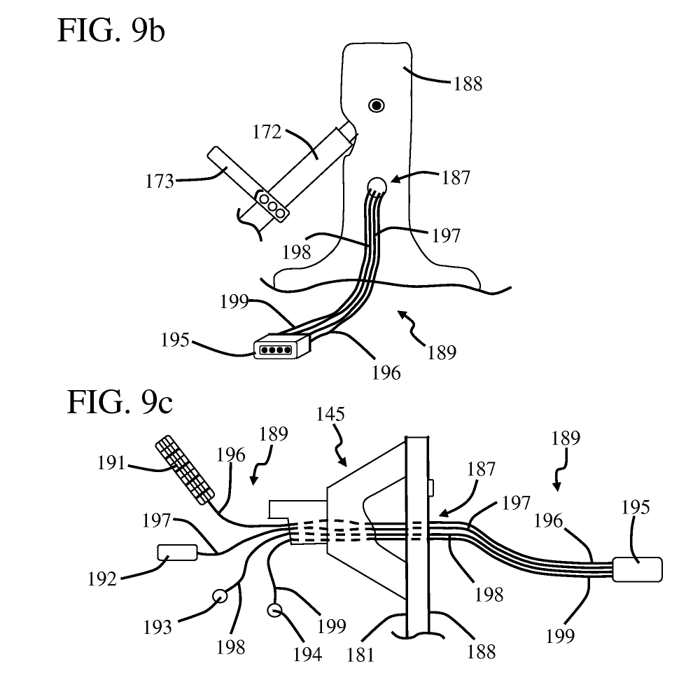

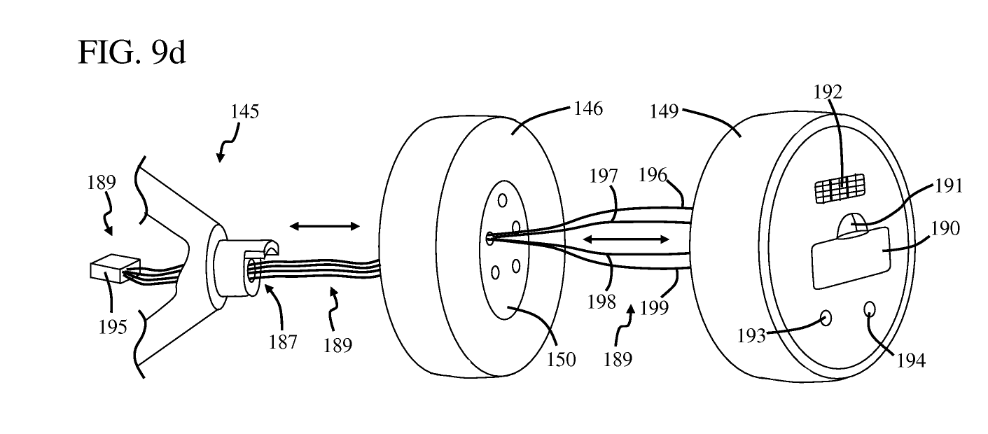

In this embodiment, tire carrier assembly 180 includes an arm plate 181 having arm portions 182 and 183. It should be noted that tire carrier assembly 180 generally includes two arm plates, such as arm plate 188 as shown in FIG. 9c, but only one is shown here for simplicity. Arm portions 182 and 183 can be separate pieces, but, in this embodiment, they are a single piece which form arm plate 181. Arm portion 182 is connected to bracket 147 at the lower connection point and extends outwardly therefrom. Further, arm portion 183 is connected to arm portion 182 and extends upwardly therefrom and carries hub unit 145. Actuator 172 is connected between the upper connection point of bracket 147 and arm portion 183 so that arm plate 181 is rotatable relative to bracket 147 in response to the actuation of actuator 172. As discussed above, actuator 172 is actuated with actuation handle 173. In this way, tire carrier assembly 180 is repeatably moveable between raised and lowered positions, as shown in FIGS. 8b and 8c.

In accordance with the invention, tire carrier assembly 180 includes a pivot arm 184 pivotably coupled with arm plate 181. Pivot arm 184 can be pivotably coupled with arm plate 181 in many different ways, but, in this embodiment, pivot arm is coupled with arm plate 181 by using a pin 186 which extends therethrough. Pin 186 extends through pivot arm 184 and arm portion 182.

Pivot arm 184 is repeatably moveable between extended and retracted positions. In the extended position, pivot arm 184 extends along arm portion 182 and, in the retracted position, pivot arm 184 extends at an angle relative to arm portion 182. In this way, tire carrier assembly 180 is repeatably moveable between extended and retracted positions. Pivot arm 184 is shown in the extended position in FIGS. 8a, 8b and 8c. Further, pivot arm 184 is shown in the retracted position in FIGS. 8d and 8e.

In this embodiment, rotary latch 130 is carried by tire carrier support structure 120 and positioned at end region 119. A distal end 185 of pivot arm 184 is repeatably moveable between latched and unlatched conditions with rotary latch 130. In the latched condition, distal end 185 is held to latch body 131 by latch plate 132 (FIG. 5a) so that the movement of pivot arm 184 is restricted. In the unlatched condition, distal end 185 is not held to latch body 131 by latch plate 132 so that the movement of pivot arm 184 is not restricted. Pivot arm 184 is shown in the latched condition in FIG. 8a and in the unlatched condition in FIGS. 8b, 8c, 8d and 8e.

It should be noted that pivot arm 184 can be moved between the latched and unlatched conditions when tire carrier assembly 180 is in the raised position and moved between the stowed and deployed positions. For example, as shown in FIG. 8c and 8d, tire carrier assembly is in the deployed position and pivot arm 184 is repeatably moveable between the extended position (FIG. 8c) and retracted position (FIG. 8d). Further, as shown in FIGS. 8a and 8e, tire carrier assembly is in the stowed position and pivot arm 184 is repeatably moveable between the extended position (FIG. 8a) and retracted position (FIG. 8e). This allows convenient access to the rear of vehicle 100 (FIG. 1).

Pivot arm 184 is repeatably moveable between the extended and retracted positions in response to lowering spare tire 146 when it is engaged with hub unit 145. This makes it easier to engage and disengage spare tire 146 to and from hub unit 145. As mentioned above, spare tire 146 is generally large in size and weight, so it is difficult to engage and disengage it to and from tire carrier assembly 180. Hence, tire carrier assembly 180 can be moved to the lowered and retracted positions to make it easier to engage and disengage spare tire 146 with hub unit 145.

FIGS. 9a, 9b and 9c are front, back and side views, respectively, of tire carrier assembly 180 carrying a vehicle accessory, in accordance with the invention. In this embodiment, tire carrier assembly 180 is carried by tire carrier support structure 120 and spare tire 146, with a tire rim 150, is carried by hub unit 145. The vehicle accessory can be of many different types, several of which will be discussed in more detail presently.

In general, tire carrier assembly 180 can carry one or more vehicle accessories. However, in this embodiment, tire carrier assembly 180 carries several vehicle accessories. For example, one vehicle accessory carried by tire carrier assembly 180 is a license plate 190 and another vehicle accessory is a license plate light 191. License plate 190 is positioned so that it can be viewed when viewing the rear of vehicle 100 and license plate light 191 is positioned to illuminate license plate 190. Examples of license plate lights are disclosed in U.S. Pat. Nos. 5,150,961, 5,192,125, and 5,255,166.

It should be noted that tire carrier assembly 180 can carry many other types of vehicle accessories. For example, in this embodiment, tire carrier assembly 180 carries a brake light 192. Brake light 192 is positioned so that it can be viewed when viewing the rear of vehicle 100. Brake light 100 is often referred to as a “third brake light” and operates as a braking indicator. Brake light 100 can be of many different types, such as those disclosed in U.S. Pat. Nos. 4,654,757, 4,937,712, 5,550,718 and 6,404,334.

In this embodiment, tire carrier assembly 180 carries backup sensors 193 and 194. Backup sensors 193 and 194 can be of many different types, but here they are motion sensors which provide an indication of motion rearward of vehicle 100. This is useful when vehicle 100 is backing up so that the driver will know if there is motion rearward of vehicle 100. An example of a vehicle backup sensor is disclosed in U.S. Pat. No. 6,788,190. It should be noted that backup sensors 193 and/or 194 can be replaced with a video camera or used in conjunction with a video camera, wherein the video camera provides a visual indication to the driver of what is behind vehicle 100. An example of a vehicle video camera is disclosed in U.S. Pat. No. 6,515,581 and U.S. Patent Application No. 20060171704.

It should be noted that license plate light 191, brake light 192 and motions sensors 193 and 194 are generally connected to the electrical system of vehicle 100. License plate light 191, brake light 192 and motions sensors 193 and 194 can be connected the electrical system of vehicle 100 in many different ways, one of which will be discussed in more detail presently.

In this embodiment, license plate light 191 is connected to a cable 196, brake light 192 is connected to a cable 197, and motions sensors 193 and 194 are connected to cables 198 and 199, respectively, as shown in FIGS. 9b and 9c. Cables 196, 197, 198 and 199 allow the flow of signals, such as power and data signals, between the vehicle electrical system and corresponding vehicle accessory. In this embodiment, cables 196, 197, 198 and 199 extend through an opening 187 that extends through arm plates 181 and 188, wherein they are connected to a connector 195. Connector 195 can be connected to a connector 109 (FIG. 1) that is connected to the electrical system of vehicle 100. Cables 196, 197, 198 and 199 and connector 195 form a wire harness 189.

It should be noted that the vehicle accessories can be carried by tire carrier assembly 180 in many different ways. For example, one or more of the vehicle accessories can be attached to spare tire 146 and/or tire rim 150. Further, one or more of the vehicle accessories can be attached to tire carrier assembly 110, such as on arm plate 115. Another way in which vehicle accessories can be carried by tire carrier assembly 110 will be discussed in more detail presently.

FIG. 9d is an exploded perspective view of hub unit 145, spare tire 146 and a spare tire cover 149, in accordance with the invention. Spare tire cover 149 can be of many different types. Examples of spare tire covers are disclosed in U.S. Pat. Nos. D294,246, 5,076,477 and 5,921,449. In this embodiment, tire rim 150 has one or more openings extending through it. The openings can be of many different types, such as openings sized and shaped to mount spare tire 146 to hub unit 145. The openings of tire rim 150 can also be for decorative purposes.

In accordance with the invention, spare tire cover 149 carries brake light 192, license plate 190, license plate light 191 and motion sensors 193 and 194. It should be noted, however, that spare tire cover 153 can carry one or more of brake light 192, license plate 190, license plate light 191 and motion sensors 193 and 194. In this way, at least one of a license plate, license plate light, brake light and motion sensor are carried by tire carrier assembly 180. In this embodiment, spare tire cover 149 is shown carrying brake light 192, license plate 190, license plate light 191 and motion sensors 192 and 193 for illustrative purposes.

In accordance with the invention, cables 196, 197, 198 and 198 extend between hub unit 145 and spare tire cover 149. Cables 196, 197, 198 and 198 can extend between hub unit 145 and spare tire cover 149 in many different ways. In this embodiment, cables 196, 197, 198 and 198 extend through tire rim 150. In particular, cables 196, 197, 198 and 198 extend through the opening in tire rim 150.

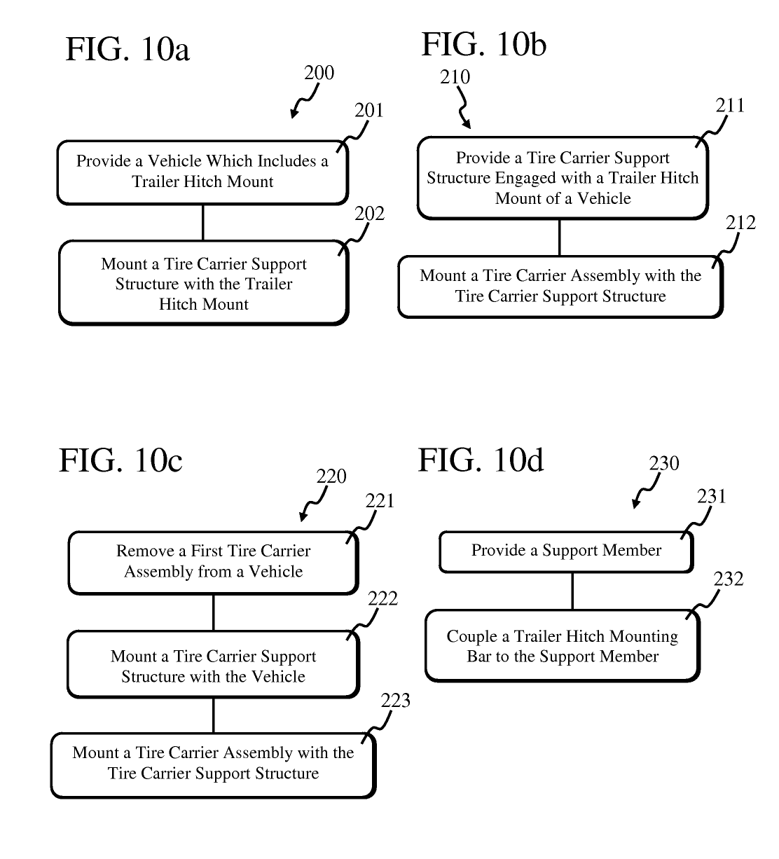

FIG. 10a is a flow diagram of a method 200, in accordance with the invention, of mounting a tire carrier support structure to a vehicle. In this embodiment, method 200 includes a step 201 of providing a vehicle which includes a trailer hitch mount.

In this embodiment, method 200 includes a step 202 of mounting a tire carrier support structure with the trailer hitch mount. The tire carrier support structure can be mounted with the trailer hitch mount in many different ways. In this embodiment, the tire carrier support structure includes a trailer hitch mounting bar sized and dimensioned to be received by the trailer hitch mount. The tire carrier support structure is mounted with the trailer hitch by slidingly engaging the trailer hitch mounting bar with the trailer hitch. In this way, the step of mounting the tire carrier support structure includes slidingly engaging it with the trailer hitch mount.

The tire carrier support structure can be of many different types. In this embodiment, the tire carrier support structure includes a base member with a sidewall member extending downwardly therefrom. The base and sidewall members extend along a bumper of the vehicle. The trailer hitch mounting bar is attached to the sidewall.

In this embodiment, the tire carrier support structure includes a trailer hitch mounting bar sized and dimensioned to be received by the trailer hitch mount. The tire carrier support structure is mounted with the trailer hitch mount by slidingly engaging the trailer hitch mounting bar with the trailer hitch. In this way, the step of mounting the tire carrier support structure includes slidingly engaging it with the trailer hitch mount.

FIG. 10b is a flow diagram of a method 210, in accordance with the invention, of mounting a tire carrier assembly to a vehicle. In this embodiment, method 210 includes a step 211 of providing a tire carrier support structure engaged with a trailer hitch mount of a vehicle.

In this embodiment, method 210 includes a step 212 of mounting a tire carrier assembly with the tire carrier support structure so it is repeatably moveable between stowed and deployed positions. The tire carrier assembly can be mounted with the tire carrier support structure in many different ways. In this embodiment, a mounting post is carried by the tire carrier support structure and extends upwardly therefrom. Further, the tire carrier assembly includes a bracket with an opening sized and shaped to receive the mounting post. The bracket can rotate about the mounting post so that the tire carrier assembly is rotatably mounted with the tire carrier support structure.

It should be noted that method 200 can include many other steps. For example, in some embodiments, a latch is positioned so it is carried by the tire carrier support structure. The latch is positioned so it can latch the tire carrier assembly in the stowed position.

The tire carrier assembly can be of many different types. For example, in some embodiments, the tire carrier assembly is repeatably moveable between raised and lowered positions. For example, the tire carrier assembly can include an actuator operatively coupled with a tire carrier arm, wherein the tire carrier arm moves between raised and lowered positions in response to actuating the actuator.

In some embodiments, the tire carrier assembly is repeatably moveable between extended and retracted positions. For example, the tire carrier assembly can include a pivot arm rotatably connected to the tire carrier arm. The pivot arm is repeatably moveable between extended and retracted positions. The pivot arm moves from the extended position to the retracted position in response to the tire carrier arm moving from the raised position to the lowered position.

FIG. 10c is a flow diagram of a method 220, in accordance with the invention, of mounting a tire carrier support structure to a vehicle. In this embodiment, method 220 includes a step 221 of removing a first tire carrier assembly from the vehicle. The first tire carrier assembly is mounted to the vehicle without using the tire carrier support structure.

Method 220 includes a step 222 of providing the tire carrier support structure and mounting it to the vehicle. In accordance with the invention, the tire carrier support structure is mounted to the vehicle by engaging it with a trailer hitch mount included with the vehicle.

Method 220 includes a step 223 of mounting a tire carrier assembly with the tire carrier support structure. In general, the tire carrier assembly mounted to the tire carrier support structure in step 223 is different from the first tire carrier assembly. However, in some embodiments, the first tire carrier assembly can be mounted to the tire carrier support structure in step 223.

FIG. 10d is a flow diagram of a method 230, in accordance with the invention, of manufacturing a tire carrier support structure. In this embodiment, method 230 includes a step 231 of providing a support member. The support member can be of many different types, such as a base member and a sidewall member. In some embodiments, the support member includes the base and sidewall members coupled together using welding. In other embodiments, the support member is a single integral piece which includes the base and support members.

In accordance with the invention, method 230 includes a step 232 of coupling a trailer hitch mounting bar to the support member. The trailer hitch mounting bar can be mounted to the support member in many different ways, such as by welding. The trailer hitch mounting bar is sized and shaped to be received by a trailer hitch mount of a vehicle.

In some embodiments, the trailer hitch mounting bar can be coupled to the support member with an extension bar. Hence, method 230 can include a step of coupling the extension bar to the support member and coupling the trailer hitch mounting bar to the extension bar. It should be noted that the extension bar and trailer hitch mounting bar can be a single integral piece. Further, one or more support arms can be coupled to the extension bar. Hence, method 230 can include a step of coupling the support arm(s) to the support member and extension bar.

The embodiments of the invention described herein are exemplary and numerous modifications, variations and rearrangements can be readily envisioned to achieve substantially equivalent results, all of which are intended to be embraced within the spirit and scope of the invention.

1. A vehicle, comprising:
a vehicle frame which carries a trailer hitch mount;
a tire carrier support structure carried by the trailer hitch mount; and
a tire carrier assembly rotatably mounted to the tire carrier support structure.

2. The vehicle of claim 1, wherein the tire carrier assembly is repeatably moveable between raised and lowered positions.

3. The vehicle of claim 1, wherein the tire carrier assembly is repeatably moveable between extended and retracted positions.

4. The vehicle of claim 1, wherein the tire carrier support structure is slidingly engaged with the trailer hitch mount.

5. The vehicle of claim 1, further including a mounting post carried by the tire carrier support structure, the tire carrier assembly being rotatably mounted to the mounting post.

6. The vehicle of claim 1, further including a closure fastener carried by the tire carrier support structure, the tire carrier assembly being repeatably moveable between latched and unlatched conditions relative to the closure fastener.

7. A vehicle, comprising:
a vehicle frame which carries a trailer hitch mount;
a tire carrier support structure slidingly engaged with the trailer hitch mount;
a mounting post and closure fastener carried by the tire carrier support structure; and
a tire carrier assembly rotatably mounted to the mounting post.

8. The vehicle of claim 7, wherein the tire carrier assembly is repeatably moveable between raised and lowered positions, and stowed and deployed positions.

9. The vehicle of claim 7, wherein the closure fastener includes a T-pin latch or a rotary latch.

10. The vehicle of claim 7, wherein the tire carrier support structure includes a sidewall member and an extension bar coupled together.

11. The vehicle of claim 7, wherein the tire carrier support structure includes a base member and sidewall member.

12. The vehicle of claim 7, wherein the tire carrier support structure is moveable between locked and unlocked conditions with the trailer hitch mount.

13. The vehicle of claim 7, wherein the tire carrier assembly includes a pivot arm repeatably moveable between extended and retracted positions.

14. The vehicle of claim 7, wherein the tire carrier support structure carries a trailer hitch.

15. The vehicle of claim 7, wherein the tire carrier assembly is repeatably moveable between latched and unlatched positions with the closure fastener.

16. The vehicle of claim 7, further including at least one of a license plate, license plate light, brake light and motion sensor carried by the tire carrier assembly.

17. A method of mounting a tire carrier support structure to a vehicle, comprising:
providing a vehicle which includes a vehicle frame having a trailer hitch;
mounting a tire carrier support structure with the trailer hitch;
rotatably mounting a tire carrier assembly with the tire carrier support structure.

18. The method of claim 17, further including attaching a mounting post to the tire carrier support structure.

19. The method of claim 18, wherein the tire carrier support structure is rotatably mounted to the tire carrier assembly by mounting it with the mounting post.

20. The method of claim 17, wherein the step of mounting the tire carrier support structure includes slidingly engaging it with the trailer hitch.

21. The method of claim 17, wherein the step of mounting the tire carrier support structure includes moving it to a locked condition with the trailer hitch.

22. The method of claim 17, further including attaching a closure fastener to the tire carrier support structure.

23. A method of mounting a tire carrier support structure to a vehicle, comprising:
providing a vehicle which includes a trailer hitch mount; and
mounting a tire carrier support structure with the trailer hitch mount.

24. A method of mounting a tire carrier assembly to a vehicle, comprising:
providing a tire carrier support structure engaged with a trailer hitch mount of a vehicle; and
mounting a tire carrier assembly with the tire carrier support structure.

25. A method of mounting a tire carrier support structure to a vehicle, comprising:
removing a first tire carrier assembly from a vehicle;
mounting a tire carrier support structure with the vehicle; and
mounting a tire carrier assembly with the tire carrier support structure.

26. A method of manufacturing a tire carrier support structure, comprising:
providing a support member; and
coupling a trailer hitch mounting bar to the support member.
